(19) United States
(12) Patent Application Publication
(10) Pub. No.: US 2009/0286074 A1
(43) Pub. Date: Nov. 19, 2009

(54) METHOD OF MANUFACTURING FOR A POROUS MEMBRANE AND THE POROUS MEMBRANCE MANUFACTURED THEREBY

(76) Inventor: Hak-Yong Kim, Chonrabuk-do (KR)

Correspondence Address: BIRCH STEWART KOLASCH & BIRCH, PO BOX 747, FALLS CHURCH, VA, 22040-0747, US

(21) Appl. No.: 11/917,328

(22) PCT Filed: Mar. 16, 2006
(86) PCT No.: PCT/KR06/00964

§ 371 Date: Dec. 12, 2007

(30) Foreign Application Priority Data
Mar. 7, 2006 (KR) 10-2006-0021302

(51) Int. Cl. B01D 69/02

(52) U.S. Cl. 428/338; 264/41

(57) ABSTRACT

Disclosed are a method of manufacturing a porous membrane and a porous membrane manufactured thereby. A polymer spinning dope in a spinning dope supply container (I) is electrically spun onto a solution (B), which is contained in a collector container (6) with a high voltage applied thereto, and whose surface is disposed within a jet stream (4) of an electrospun polymer spinning dope, through spinning nozzles (2) with a high voltage applied thereto, thereby forming a porous membrane on the surface of the solution (B). The prepared porous membrane has pores having an average diameter of 0.02 to 10 μm uniformly formed thereon. It is possible to prepare a porous membrane with pores of a given size uniformly formed thereon by a more simple procedure.

### TECHNICAL FIELD

The present invention relates to a method of manufacturing a porous membrane, and a porous membrane manufactured thereby, and more particularly, to a method of easily manufacturing a porous membrane with pores of a given size uniformly formed thereon using an electrospinning method.

Porous membranes are widely used as material for giving the moisture permeability and water resistance function to leisure clothes, shoes, etc., or as filter material.

### BACKGROUND ART

As a conventional technique for preparing a porous membrane, the U.S. Pat. No. 5,910,277 proposes a process of making a porous polytetrafluoroethylen (PTFE) membrane by mixing a fine powder of polytetrafluoroethylene with a liquid lubricant, molding the mixture into a sheet by an extrusion method and the like, removing the liquid lubricant by a heating method, and stretching this sheet in the machine direction,

Meanwhile, the U.S. Pat. No. 6,017,455 discloses a process of preparing a porous aromatic polyether ketone membrane by dissolving an aromatic polyether ketone in an approximately 88% sulfuric acid solvent, preparing it into a film on a glass plate, coagulating the prepared film in 73% sulfuric acid, and then removing the residual sulfuric acid solution left on the film using water, alcohol, etc. The thus-prepared porous aromatic polyether ketone membrane has a crystallinity of 10% or less. The membrane surface contacted with the glass plate has open pores having an average pore diameter of 1.2 μm at an open pore ratio of 50%, while the membrane surface not contacted with the glass plate has open pores having an average pore diameter of 1.1 μm at an open pore ratio of 50%.

And, the U.S. Pat. No. 6,284,138 discloses a process of preparing a porous membrane having pores of 0.1 to 0.2 μm by dissolving a polymer with polyacrylsulfone (PAS) and polyethersulfone (PES) mixed at a predetermined ratio in dimethylaceteamide (DMAc), coating this solution at a predetermined thickness by use of a plate, coagulating it in a coagulating solvent of dimethylaceteamide (DMAc) and water to prepare a membrane, and then removing the residual solvent.

The aforementioned conventional techniques have problems including the complexity of the procedures, the non-uniformity of the size and distribution density of pores formed on the prepared porous membrane and so on because the coagulating solution has to be used or it has to be removed after mixing organic particles or organic/inorganic particles therein when preparing the porous membrane.

It is an object of the present invention to provide a process of preparing a porous membrane with pores of a given size uniformly formed thereon using an electrospinning method by a simple procedure.

### DETAILED DESCRIPTION OF THE INVENTION

### Technical Problems

The present invention is intended to provide a method of manufacturing a porous membrane with pores of a given size uniformly formed thereon using an electrospinning method by a simple procedure. Additionally, the present invention is intended to provide a porous membrane which is prepared using an electrospinning method, and which has pores having an average diameter of 0.02 to 10 μm uniformly formed thereon.

For these purposes, the present invention provides a process of preparing a porous membrane by disposing the surface of a solution (hereinafter, referred to as a “collector solution”) contained in a collector container within a jet stream region of a polymer spinning dope formed during an electrospinning process, such that the jet stream and the collector solution are contacted with each other.

### Technical Solutions

The method of manufacturing a porous membrane according to the present invention is characterized in that: a polymer spinning dope in a spinning dope supply container 1 is electrically spun onto a solution (B), which is contained in a collector container 6 with a high voltage applied thereto, and whose surface is disposed within a jet stream 4 of an electrospun polymer spinning dope, through spinning nozzles 2 with a high voltage applied thereto, thereby forming a porous membrane on the surface of the solution (B).

Furthermore, the porous membrane prepared in the present. invention has pores having an average diameter of 0.02 to 10 μm uniformly formed over the entire membrane.

Hereinafter, the present invention will be described in detail with reference to the accompanying drawings.

Typically, when a polymer spinning dope is electrically spun through nozzles 2, the electrospun polymer spinning dope forms a tailor cone 3 as shown in FIG. 2. The tailor cone is transformed into the jet stream 4 by an electric power, and polymer chains of a given size are separated in an incomplete region where the polymer chains and solvent contained in the jet stream are separated from each other, thereby forming nano fibers 5. FIG. 2 is a schematic perspective view showing the step of forming nano fibers using an electrospinning method.

In the present invention, in an electrospinning process, a porous membrane is prepared by contacting a solvent, such as water, with the jet stream region before the formation of nano fibers. More specifically, the present invention relates to a process of preparing a porous membrane with pores of a given size uniformly formed thereon by contacting a solvent, such as water, with the jet stream before nano fibers are formed as polymer chains and the solvent both contained in the jet stream are separate from each other, and then volatilizing the solvent from the polymer solution as the jet stream is spread on the surface of the solvent.

Hereinafter, the present invention is described in detail with reference to FIG. 1.

FIG. 1 is a schematic view of a process of preparing a porous membrane according to the present invention. A (+) charge is applied to to a polymer spinning supply container 1 through a high voltage generator (A), and a predetermined amount of a polymer spinning dope is discharged through nozzles 2 attached to the polymer spinning dope supply container 1. The spinning dope discharged through the nozzles 2 forms a tailor cone 3 at first, and then is transformed into a jet stream 4 by an electric power. The formed jet stream 4 is immersed in a solution (hereinafter, referred to as a “collector solution”) contained in a collector container 6 with a high voltage applied thereto. The collector container 6 is charged to a (−) or (+) voltage from the high voltage generator (A). The immersed jet stream 4 becomes incomplete, and forms a uniform membrane on the surface of the collector solution composed of water and various kinds of solvents. Simultaneously with the formation of a membrane, the solvent is spread, and as the solvent is spread, the polymer and the solvent are separated from each other and pores are formed on the membrane, thereby preparing a porous membrane.

By immersing the jet stream region (d) in the collector solution (B) composed of water and various kinds of solvents, a porous membrane can be formed. If the jet stream region is immersed in the collector solution (B) composed of water or various kinds of solvents after it is deviated from the incomplete region after the formation of a jet stream, it forms nano fibers or is transformed into a bead shape, thereby failing to prepare a membrane. A representative example of such a phenomenon is shown in FIG. 10, which is an electron micrograph of a sample prepared by Comparative Example. This shows that if the jet stream is immersed in the collector solution (B) outside of the jet stream region (d), some part forms fibers and some part forms a film but it is difficult to prepare a uniform membrane. Hence, it is clear that the distance (hereinafter, “spinning distance”) between the nozzle tip and the surface of the collector solution is very important.

Although the spinning distance cannot be measured indiscriminately because the length of the jet stream varies depending on the type of every polymer to be used, it is usually 5 cm or less in most cases. Thus, in case of polymers having a large length of the jet stream, in particular, in case of polymers having a high conductivity, the length of the jet stream becomes greater in general. Therefore, it is preferred to adjust the spinning distance considering the conductivity of the polymer spinning dope used or the like. The spinning distance is 0.1 to 5.0 cm, and more preferably, 0.1 to 1.5 cm.

In the present invention, a porous membrane formed on the surface of the collector solution (B) is separated from the collector solution (B) by a substrate 8 passing through the collector solution (B), and thereafter squeezed, dried, and wound. The porous membrane formed on the surface of the collector solution (B) is very thin, thus it is very difficult to wind it into a given form without using the substrate 8. The substrate 8 is supplied from a substrate supply roller 7, and separates the porous membrane formed on the surface of the collector solution (B) from the collector solution (B) while sequentially passing through feed rollers 9 and 10 put in the collector solution (B). The substrate 8 includes a film or a mesh. The thus-separated porous membrane is squeezed while passing through a squeezing roller 11, being placed on the substrate 8, and then dried while passing through a drier 12, and then wound on a winding machine 13.

Additionally, in the present invention, the surface height, concentration, temperature, and pH of the collector solution (B) are kept constant. Specifically, a given amount of the collector solution is supplied into the collector container by a collector container supply device 14, a collector solution of the same amount as the supplied collector solution is discharged out of the collector container by a collector solution discharge device 15, thereby keeping constant the surface height of the collector solution (B). Besides, the concentration and pH of the collector solution (B) is kept constant by treating the collector solution discharged out of the collector container by a solvent removal device 16 in the collector solution such that the solvent in the collector solution is removed, and the temperature of the collector solution (B) is kept constant by a heating or the like.

Useable polymers of the present invention include (I) natural polymers, such as cellulose, chitosan, etc., and copolymers or mixtures thereof, (II) thermoplastic resins, such as polyester, nylon, fluoride resins, etc., and copolymers or mixtures thereof, (III) thermosetting resins such as melamine, epoxy, etc., and copolymers or mixtures thereof, and (IV) sol-gel containing inorganic materials, such as aluminum, titanium, etc.

The solution (B) contained in the collector container 6 is one selected from water and a solvent. The solvent is one selected from the group consisting of methylene chloride, alcohol, benzene, toluene, sulfuric acid and mixtures thereof. An organic or inorganic matter serving as various kinds of additives may be added to the solvent, or a surfactant may be added thereto.

The size of the pores formed on the porous membrane varies depending on the concentration of polymers in the spinning dope or the pH, temperature, and electrical conductivity of the collector solution (B). Thus, the size of the pores can be adjusted by adjusting them.

The porous membrane prepared in the process according to the present invention has pores having an average diameter of 0.02 to 10 μm uniformly formed thereon.

### Advantageous Effects

The present invention is able to prepare a porous membrane with pores of a given size uniformly formed thereon by a simple procedure using an electrospinning method.

### BRIEF DESCRIPTION OF THE DRAWINGS

FIG. 1 is a schematic view of a process of the present invention;

FIG. 2 is a schematic perspective view showing the step of forming nano fibers using an electrospinning method;

FIG. 3 is an electron micrograph of a porous polycaprolactone membrane prepared by Example 1;

FIG. 4 is an electron micrograph of a porous polycaprolactone membrane prepared by Example 2;

FIG. 5 is an electron micrograph of a porous polycaprolactone membrane prepared by Example 3;

FIG. 6 is an electron micrograph of a porous polycaprolactone membrane prepared by Example 4;

FIG. 7 is an electron micrograph of a porous polycaprolactone membrane prepared by Example 5;

FIG. 8 is an electron micrograph of a porous polycaprolactone membrane prepared by Example 6;

FIG. 9 is an electron micrograph of a porous polycaprolactone membrane prepared by Example 7; and

FIG. 10 is an electron micrograph of a porous polycaprolactone membrane prepared by Comparative Example 1;

### EXPLANATION OF REFERENCE NUMERALS FOR MAIN COMPONENTS IN THE DRAWINGS

A: high voltage generator
B: solution contained in collector container (collector solution)
1: spinning dope supply container
2: nozzle
3: tailor cone
4: jet stream
5: nano fiber
6: collector container
7: substrate supply roller
8: substrate
9,10: substrate feed roller
11: squeezing roller
12: drier
13: winding roller
14: collector container supply device
15: collector solution discharge device
16: solvent removal device in collector solution
d: jet stream region

### BEST MODE FOR CARRYING OUT THE INVENTION

The present invention is now understood more concretely by comparison between examples of the present invention and comparative examples. However, the present invention is not limited to such examples.

### Example 1

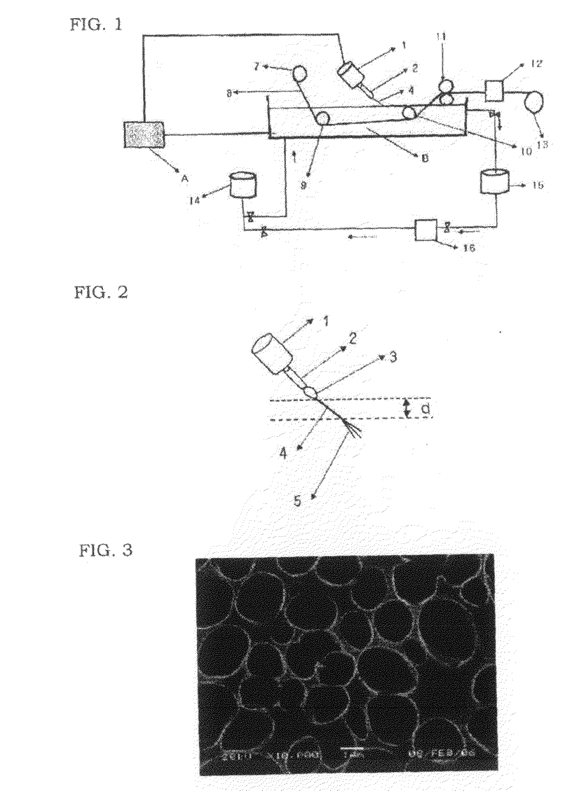

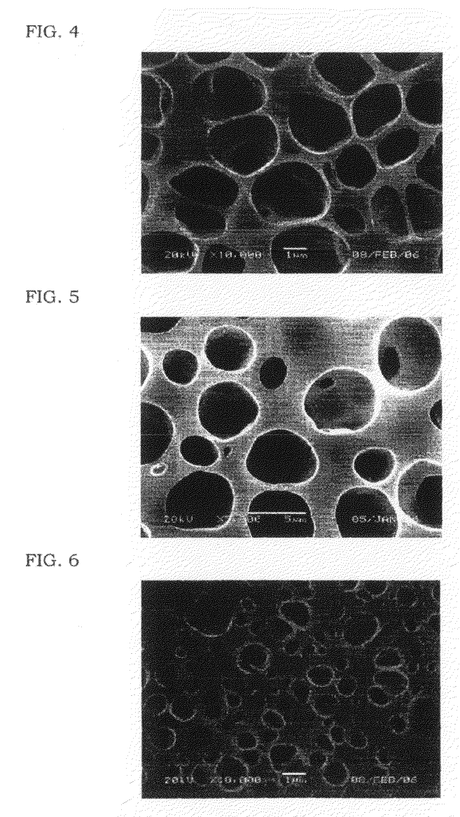

A polymer spinning dope was prepared by dissolving a poly(ε-caprolactone) polymer (purchased from Aldrich Chemical Company) having a number average molecular weight of 80,000 in a mixed solvent of methylene chloride/N,N′-dimethyl formamide (volume ratio: 70/30) at a concentration of 8% by weight. The polymer spinning dope had a surface tension of 31 mN/m, a solution viscosity of 200 centipoise at an ambient temperature, and an electrical conductivity of 0.021 mS/m. Then, as shown in FIG. 1, the thusly-prepared polymer spinning dope was electrically spun onto a solution (B), which is contained in a collector container 6 with a high voltage applied thereto, and whose surface is disposed within a jet stream 4 of an electrospun polymer spinning dope, through spinning nozzles 2 with a high voltage applied thereto, thereby forming a porous membrane on the surface of the solution (B). The porous membrane was separated from the solution (B) by use of a substrate 8 passing through the solution (B), squeezed by a squeezing roller 11, dried by a drier 12, and then wound by a winding machine 13. The diameter of the nozzles used was 0.8 mm, the nozzles were arranged at 2 cm intervals, and a unit block where 50 nozzles are arranged for a length of 110 cm in the width direction was used. A nozzle plate consisting of 10 unit blocks was used, and the nozzles arranged on the 10 unit blocks were uniformly and diagonally arranged in the membrane traveling direction (machine direction), thereby acquiring the uniformity of a membrane to be formed. The electrospinning distance was 0.2 cm, and a solution having a pH of 3.0 was used as the collector solution. In order to acquire the uniformity of the thickness of the membrane, the membrane was prepared by reciprocating the 10 unit blocks at 1 cm/min in the width direction. A predetermined amount of the solution (B) was supplied into the collector container by a collector solution supply device 14 so that the height of the surface of the solution (B) in the collector container is kept constant, and simultaneously a predetermined amount of the solution (B) is discharged from the collector container by the collector solution discharge device 15, the temperature, concentration, and pH in the discharged solution (B) were adjusted by a solvent removal device 16 for the collector solution, and then the solution (B) was re-supplied to the collector container. A polypropylene membrane having a thickness of 500 μm was used as the substrate 8, and the substrate was supplied into the collector solution at a velocity of 50 m/min through feed rollers 9 and 10. The pressure of the squeezing roller 11 was 1 kg/cm², the drier 12 performed drying using a 35° C. air, and the winding velocity was 50 cm/min. The prepared porous film had open pores having a size of 1.98 μm at an open pore ratio of 54.4%, and an electron micrograph thereof was as shown in FIG. 3.

### Example 2

A porous membrane was prepared under the same conditions as in Example 1 except that a solution having a pH of 5 was used as the solution (B) contained in the collector container 4.

The prepared porous membrane had open pores having a size of 2.65 μm at an open pore ratio of 60.1%, and an electron micrograph thereof was as shown in FIG. 4.

### Example 3

A porous membrane was prepared under the same conditions as in Example 1 except that a solution having a pH of 7 was used as the solution (B) contained in the collector container 4.

The prepared porous membrane had open pores having a size of 9.78 μm at an open pore ratio of 38.6%, and an electron micrograph thereof was as shown in FIG. 5.

### Example 4

A porous membrane was prepared under the same conditions as in Example 1 except that a solution having a pH of 9 was used as the solution (B) contained in the collector container 4.

The prepared porous membrane had open pores having a size of 0.39 μm at an open pore ratio of 27.1%, and an electron micrograph thereof was as shown in FIG. 6.

### Example 5

A porous membrane was prepared under the same conditions as in Example 1 except that a solution having a pH of 11 was used as the solution (B) contained in the collector container 4.

The prepared porous membrane had open pores having a size of 0.82 μm at an open pore ratio of 31.6%, and an electron micrograph thereof was as shown in FIG. 7.

### Example 6

A porous membrane was prepared under the same conditions as in Example 1 except that the concentration of polymer in the polymer spinning dope was changed to 9% by weight.

The prepared porous membrane had open pores having a size of 1.99 μm at an open pore ratio of 70.2%, and an electron micrograph thereof was as shown in FIG. 8.

### Example 7

A porous membrane was prepared under the same conditions as in Example 1 except that the concentration of polymer in the polymer spinning dope was changed to 10% by weight.

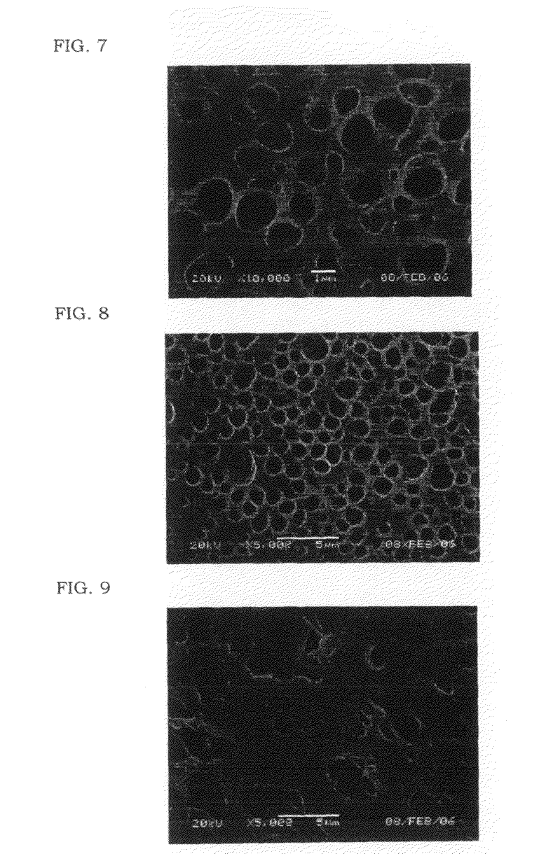

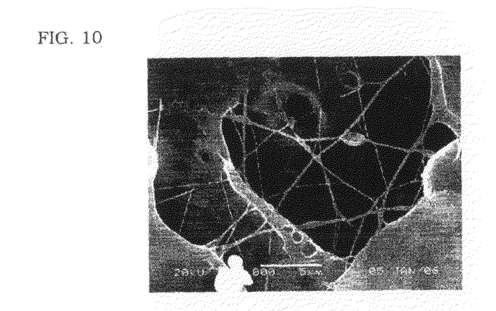

The prepared porous membrane had open pores having a size of 3.23 μm at an open pore ratio of 17.5%, and an electron micrograph thereof was as shown in FIG. 9.

### Comparative Example 1

The polymer spinning dope of Example 1 was electrically spun onto a solution (B), which is contained in a collector container 6 with a high voltage applied thereto, and whose surface is disposed within a jet stream 4 of an electrospun polymer spinning dope, through spinning nozzles 2 with a high voltage applied thereto, thereby forming a porous membrane. The electrospinning distance (S) was 2 cm, and a solution having a PH of 3.0 was used as the collector solution. In this case, the collector solution is disposed outside of the jet stream region, and the electrospun polymer spinning dope is contacted with the collector solution after the formation of nano fibers, which makes it difficult to form a porous membrane. An electron micrograph of the prepared porous membrane was as shown in FIG. 10.

### INDUSTRIAL APPLICABILITY

The porous membrane of the present invention is used as material for giving the moisture permeability and water resistance function to leisure clothes, shoes, etc., or as filter material.

What is claimed is:

1. A method of manufacturing a porous membrane, characterized in that: a polymer spinning dope in a spinning dope supply container 1 is electrically spun onto a solution (B), which is contained in a collector container 6 with a high voltage applied thereto, and whose surface is disposed within a jet stream 4 of an electrospun polymer spinning dope, through spinning nozzles 2 with a high voltage applied thereto, thereby forming a porous membrane on the surface of the solution (B).

2. The method of claim 1, wherein the solution (B) contained in the collector container 6 is one selected from water and a solvent.

3. The method of claim 2, wherein the solvent is one selected from the group consisting of methylene chloride, alcohol, benzene, toluene, sulfuric acid and mixtures thereof.

4. The method of claim 1, wherein the size of pores are controlled by adjusting at least one of the polymer concentration in the spinning dope and the temperature, pH, and electrical conductivity of the solution (B) contained in the collector container 6.

5. The method of claim 1, wherein the distance (spinning distance) between the lower end of the nozzles 2 and the surface of the solution (B) contained in the collector container 6 is 0.1 to 5.0 cm.

6. The method of claim 5, wherein the distance (spinning distance) between the lower end of the nozzles 2 and the surface of the solution (B) contained in the collector container 6 is 0.1 to 1.5 cm.

7. The method of claim 1, wherein the porous membrane formed on the surface of the solution (B) contained in the collector container 6 is separated from the solution (B) by a substrate 8 passing through the solution (B), and then squeezed, dried, and wound.

8. The method of claim 7, wherein the substrate 8 is a film or mesh.

9. The method of claim 1, wherein a predetermined amount of the solution (B) is supplied into the collector container so that the height of the surface of the solution (B) in the collector container is kept constant, and simultaneously a predetermined amount of the solution (B) is discharged from the collector container, the temperature, concentration, and pH in the discharged solution (B) are adjusted, and then the solution (B) is re-supplied to the collector container.

10. A porous membrane which is manufactured in the process of claim 1, and has pores having an average diameter of 0.02 to 10 μm uniformly formed thereon.
